(19) United States
(12) Patent Application Publication
(10) Pub. No.: US 2020/0407491 A1
(43) Pub. Date: Dec. 31, 2020

(54) Semiconductor Compound, Use Thereof and Hydrogen Production System

(71) Applicant: National Tsing Hua University, Hsinchu (TW)

(72) Inventors: Ho-Hsiu Chou, Hsinchu (TW); Chih-Li Chang, Hsinchu (TW); Wei-Cheng Lin, Hsinchu (TW)

(21) Appl. No.: 16/510,008

(22) Filed: Jul. 12, 2019

(30) Foreign Application Priority Data
Jun. 26, 2019 (TW) 108122435

(51) Int. Cl. C08G 61/12; C25B 1/00; C25B 1/02; C25B 11/04

(52) U.S. Cl. CPC C08G 61/126; C25B 1/003; C25B 1/02; C25B 11/0447; C08G 2261/374; C08G 2261/1424; C08G 2261/3142; C08G 2261/3241; C08G 2261/334; C08G 2261/12

(57) ABSTRACT

The present disclosure provides a semiconductor compound, which includes a metal complex unit and a conjugate unit. The metal complex unit includes a coordination center and a plurality of ligands. The coordination center is a metal ion or a metal atom, and the ligands are linked with the coordination center. The conjugate unit is linked with the metal complex unit by covalent bond.

### CROSS-REFERENCE TO RELATED APPLICATION

This application claims priority to Taiwanese Patent Application No. 108122435 filed Jun. 26, 2019, the disclosure of which is hereby incorporated by reference in its entirety.

### BACKGROUND

### Technical Field

The present disclosure relates to a semiconductor compound, a use thereof and a hydrogen production system. More particularly, the present disclosure relates to a semiconductor compound containing a metal complex unit, a use thereof and a hydrogen production system.

### Description of Related Art

Energy can provide a source of many kinds of power for the production and life of people. With the development of the economy, the energy crisis is becoming more and more serious, and the environmental problems caused by the use of fossil fuels have seriously affected the survival of people. Therefore, the development and use of green and sustainable new energy sources has become very important. Among the many new energy sources, solar energy is abundant and has the advantage for not causing any environmental pollution. Currently, most of the researches are to convert solar energy into chemical energy, electric energy, etc., and store them in a centralized manner. Among the many conversion pathways of solar energy, converting solar energy into hydrogen-supported chemical energy directly is one of the most concerned.

In the past, the materials of solar hydrogen production that use to improve the efficiency, generally, a co-catalyst having a metal is added to increase the efficiency. The preparation method is to add the co-catalyst in the solution system directly. Due to the hydrogen produced by the polymer is not dissolved in water easily, it is necessary to add methanol to help dissolve the polymer, resulting in the toxicity increase of the solution system.

Therefore, how to improve the structure of the hydrogen-producing catalyst, so that it has good hydrogen production efficiency, and can avoid increasing the toxicity of the solution system and has environment friendly, which is the goal of the relevant industry.

### SUMMARY

According to one aspect of the present disclosure, a semiconductor compound is provided. The semiconductor compound includes a metal complex unit and a conjugate unit. The metal complex unit includes a coordination center and a plurality of ligands. The coordination center is a metal ion or a metal atom. The ligands are linked with the coordination center. The conjugate unit is linked with the metal complex unit by covalent bond.

According to another aspect of the present disclosure, a use of the semiconductor compound according to the aforementioned aspect is provided, which is used as a photocatalyst.

According to further another aspect of the present disclosure, a hydrogen production system is provided. The hydrogen production system includes the semiconductor compound according to the aforementioned aspect.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram of a hydrogen production system according to one embodiment of the present disclosure.

FIG. 2A is a TEM image of the semiconductor particle of COM1.

FIG. 2B is an EDX image of the semiconductor particle of COM1.

FIG. 3A is a TEM image of the semiconductor particle of EX1.

FIG. 3B is an EDX image of the semiconductor particle of EX1.

FIG. 4A is a TEM image of the semiconductor particle of EX2.

FIG. 4B is an EDX image of the semiconductor particle of EX2.

FIG. 5A is a TEM image of the semiconductor particle of EX3.

FIG. 5B is an EDX image of the semiconductor particle of EX3.

FIG. 6A is a TEM image of the semiconductor particle of EX4.

FIG. 6B is an EDX image of the semiconductor particle of EX4.

FIG. 7A is a TEM image of the semiconductor particle of EX5.

FIG. 7B is an EDX image of the semiconductor particle of EX5.

FIG. 8A is a TEM image of the semiconductor particle of EX6.

FIG. 8B is an EDX image of the semiconductor particle of EX6.

FIG. 9 is a UV-Vis absorption spectrum and a photoluminescence spectrum of the semiconductor particle of COM1, EX1 to EX6.

FIG. 10 is a result diagram of the photocatalytic hydrogen evolution from water splitting of system A, system B and system C.

FIG. 11 is a result diagram of the photocatalytic hydrogen evolution from water splitting of the semiconductor particle of COM1, EX1 to EX6.

FIG. 12 is a result diagram of the photocatalytic hydrogen evolution from water splitting of the semiconductor particle of EX2 and EX5.

FIG. 13 is a result diagram of the photocatalytic hydrogen evolution from water splitting of the semiconductor particle of COM1, EX2 and COM2.

### DETAILED DESCRIPTION

In the present disclosure, if a group is not indicated specifically which is substituted or not, the group can be represented the substituted or unsubstituted group. For example, “alkyl group” can be represented the substituted or unsubstituted alkyl group.

In the present disclosure, the range represented by “a numerical value to another numerical value” is a schematic representation that avoids enumerating all the numerical values in the range of the specification. Therefore, the recitation of a particular range of numerical values includes any numerical value in the range of the numerical values and the smaller range of numerical values defined by any numerical value in the range of numerical values. As stated in the specification, the range of any numerical value is the same as the range of the smaller numerical value. For example, the range of “0.1 wt% to 1 wt%” includes the range of “0.5 wt% to 0.8 wt%” whether the specification is list other numerical values or not.

In the present disclosure, the compound structure can be represented by a skeleton formula, and the representation can omit the carbon atom, the hydrogen atom and the carbon-hydrogen bond. In the case that the functional group is depicted clearly in the structural formula, the depicted one is preferred.

A Semiconductor Compound

A semiconductor compound is provided of the present disclosure, which includes a metal complex unit and a conjugate unit. The metal complex unit includes a coordination center and a plurality of ligands. The coordination center is a metal ion or a metal atom. The ligands are linked with the coordination center. The conjugate unit is linked with the metal complex unit by covalent bond. Therefore, when the semiconductor compound is dispersed in a solution system, the increase of the toxicity of the solution system can be prevented.

The aforementioned ligands are linked with the coordination center, and the connection can be a covalent link or a coordinate link, depending on a bridging atom of the ligands and the type of the metal ion / metal atom of the coordination center.

The semiconductor compound can be a polymer or a small molecule compound. When the semiconductor compound is the polymer, it is favorable for improving the stability. For example, it can have the better acid and alkali resistance and the light stability.

A coordination number of the metal complex unit is four or six. The coordination center can be platinum, zinc, cobalt, nickel, iron, copper, ruthenium, rhodium, iridium, palladium, platinum ion, zinc ion, cobalt ion, nickel ion, iron ion, copper ion, ruthenium ion, rhodium ion, iridium ion or palladium ion. When the coordination center is the metal ion, the valence number of the metal ion is not particularly limited. The same kind of the metal can have different valence numbers depending on the type of the ligand. For example, the platinum ion in the metal complex unit can be a divalent ion (Pt²⁺) or a tetravalent ion (Pt⁴⁺).

Each of the ligands can be a bidentate ligand, and the bidentate ligand can be linked to the coordination center by two nitrogen atoms, two carbon atoms, a nitrogen atom and a carbon atom or two oxygen atoms. The atom linked with the ligand and the coordination center is referred to as a bridging atom. The bridging atom of the aforementioned bidentate ligand can be represented by N [symbol] N \grave{ } C [symbol] C \grave{ } N [symbol] C \grave{ } O [symbol] O. Each of the ligands can include a structure represented by formula (i-1), formula (i-2), formula (i-3) or formula (i-4), wherein the ligand is linked to the coordination center by a carbon atom, a nitrogen atom or an oxygen ion with *:

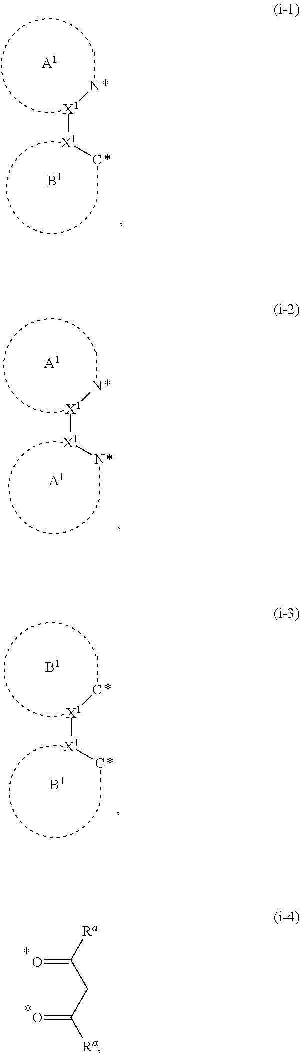

wherein each X¹ can be independently the carbon atom or the nitrogen atom, each R^{a} can be independently a hydrogen atom, a deuterium atom, a halogen atom or a monovalent group, each A¹ can be independently a substituted or an unsubstituted divalent nitrogen-containing heterocycle, each B¹ can be independently a substituted or an unsubstituted divalent organic ring containing an unsaturated bond.

The monovalent group of R^{a} can be a hydroxyl group, a cyano group, a nitro group, a substituted or an unsubstituted amino group, an amide group, a hydrazine group, a hydrazine group, a carboxyl group or a salt thereof, a sulfonic acid group or a salt thereof, a phosphoric acid group or a salt thereof, a substituted or an unsubstituted alkyl group of 1 to 60 carbon atoms, a substituted or an unsubstituted alkenyl group of 2 to 60 carbon atoms, a substituted or an unsubstituted alkynyl group of 2 to 60 carbon atoms, a substituted or an unsubstituted alkoxy group of 1 to 60 carbon atoms, a substituted or an unsubstituted cycloalkyl group of 3 to 10 carbon atoms, a substituted or an unsubstituted cycloalkenyl group of 3 to 10 carbon atoms, a substituted or an unsubstituted heterocycloalkyl group of 3 to 10 carbon atoms, a substituted or an unsubstituted heterocycloalkenyl group of 3 to 10 atoms, a substituted or an unsubstituted aryl group of 6 to 30 carbon atoms, a substituted or an unsubstituted aryloxy group of 6 to 30 carbon atoms, a substituted or an unsubstituted arylthio group of 6 to 30 carbon atoms, a substituted or an unsubstituted heteroaryl group of 2 to 30 carbon atoms, a substituted or an unsubstituted aldehyde group or a substituted or an unsubstituted silyl group. The aforementioned “substituted” means that at least one hydrogen atom can be substituted by the deuterium atom, the halogen atom or the monovalent group (hereinafter, the deuterium atom, the halogen atom or the monovalent group which substitutes the hydrogen atom is referred to as a substituted group). The monovalent group is as described in the above paragraph. Furthermore, when at least two hydrogen atoms are substituted, the kinds of the substituted group can be the same or different. The common substituted group includes but is not limited to the alkyl group of 1 to 60 carbon atoms, the aryl group of 6 to 30 carbon atoms or the heteroaryl group of 2 to 30 carbon atoms.

Each A¹ can be independently the substituted or the unsubstituted divalent nitrogen-containing heterocycle, which means that at least one hydrogen atom on the divalent nitrogen-containing heterocycle can be substituted by the deuterium atom, the halogen atom or the monovalent group. The monovalent group is as described in the above paragraph. Furthermore, when at least two hydrogen atoms are substituted, the kinds of the substituted group can be the same or different. Alternatively, the hydrogen atoms on the divalent nitrogen-containing heterocycle are not substituted with the substituted group.

The divalent nitrogen-containing heterocycle can be pyrrol, imidazole, pyrazole, triazole, thiazole, oxazole, isothiazole, isoxazole, benzothiazole, benzoimidazole, benzooxazole, pyridine, pyrazine, pyrimidine, pyridazine, isoindole, indole, indazole, purine, isoquinoline, quinoline, phthalazine, naphthyridine, quinoxaline, quinazoline, cinnoline, phenanthridine, acridine, phenanthroline or phenoxazine.

Each B¹ can be independently the substituted or the unsubstituted divalent organic ring, which means that at least one hydrogen atom on the divalent organic ring can be substituted by the deuterium atom, the halogen atom or the monovalent group. The monovalent group is as described in the above paragraph. Furthermore, when at least two hydrogen atoms are substituted, the kinds of the substituted group can be the same or different. Alternatively, the hydrogen atoms on the divalent organic ring are not substituted with the substituted group.

The divalent organic ring can be benzene, pentalene, indene, naphthalene, azulene, heptalene, indacene, acenaphthylene, fluorene, spiro-fluorene, phenalene, phenanthrene, anthracene, fluoranthene, triphenylene, pyrene, chrysene, thiophene, pyrrol, imidazole, pyrazole, triazole, thiazole, oxazole, isothiazole, isoxazole, benzothiazole, benzoimidazole, benzooxazole, pyridine, pyrazine, pyrimidine, pyridazine, isoindole, indole, indazole, purine, isoquinoline, quinoline, phthalazine, naphthyridine, quinoxaline, quinazoline, cinnoline, phenanthridine, acridine, phenanthroline or phenoxazine.

The conjugate unit can be an aromatic-based derivative or a hetroaromatic-based derivative.

The conjugate unit can be an electron donor, an electron acceptor or a combination of the electron donor and the electron acceptor. That is, the conjugate unit only includes the electron donor, or can only include the electron acceptor, or can include the electron donor and the electron acceptor simultaneously. The number of the electron donor and the electron acceptor can be adjusted elastically. For example, the conjugate unit can be but is not limited to one electron donor coupled with one electron accepter. Further example, the conjugate unit can be one electron donor coupled with two electron accepters. In addition, the arrangement of the electron donor and the electron acceptor is not particularly limited, and can be adjusted elastically according to the required characteristics.

Specifically, the conjugate unit can include a structure represented by formula (ii-1), formula (ii-2), formula (ii-3), formula (ii-4), formula (ii-5), formula (ii-6), formula (ii-7), formula (ii-8), formula (ii-9), formula (ii-10) or formula (ii-11):

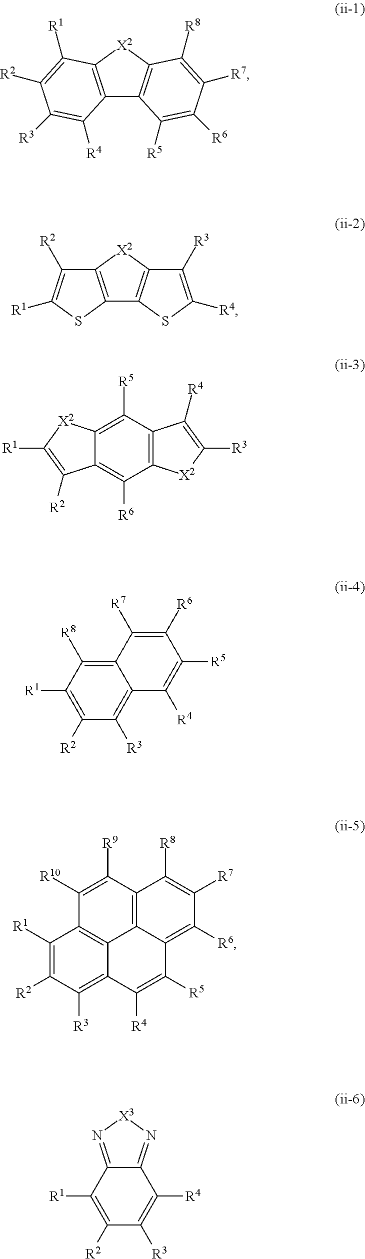

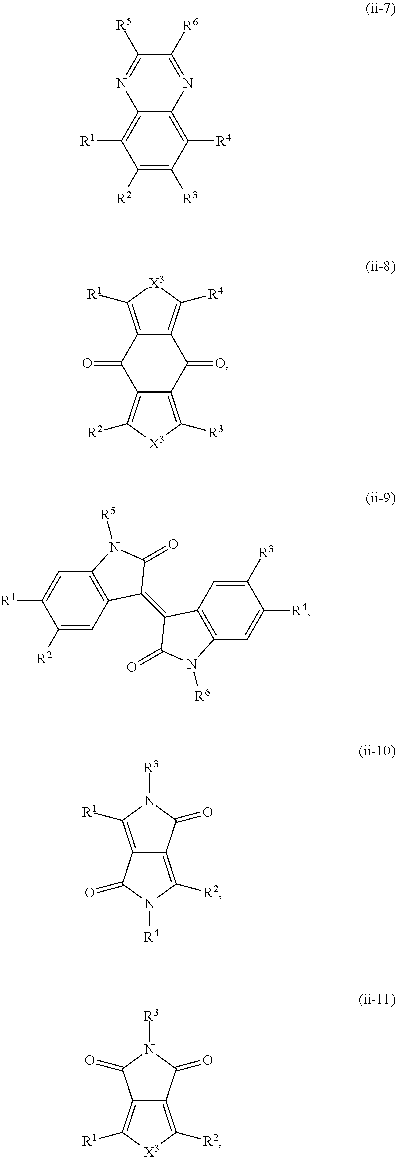

wherein each X² can be independently S, Se, C(R¹¹)(R¹²), N(R¹³) or Si(R¹⁴)(R¹⁵), each X³ can be independently S, O, Se or N(R¹³), R¹ to R¹⁵ can be each independently the hydrogen atom, the deuterium atom, the halogen atom or the monovalent group. The monovalent group in the conjugate unit can be the same as that in the aforementioned R^{a}, and will not be further described herein. In the formula (ii-1) to the formula (ii-11), the formula (ii-1) to the formula (ii-5) are more suitable used as the electron donor, the formula (ii-6) to the formula (ii-11) are more suitable used as the electron accepter. However, whether the formula (ii-1) to the formula (ii-11) belongs to the electron donor or the electron accepter depending on the group which is linked, therefore is not particularly limited.

The semiconductor compound can include a structure represented by formula (I) or formula (II):

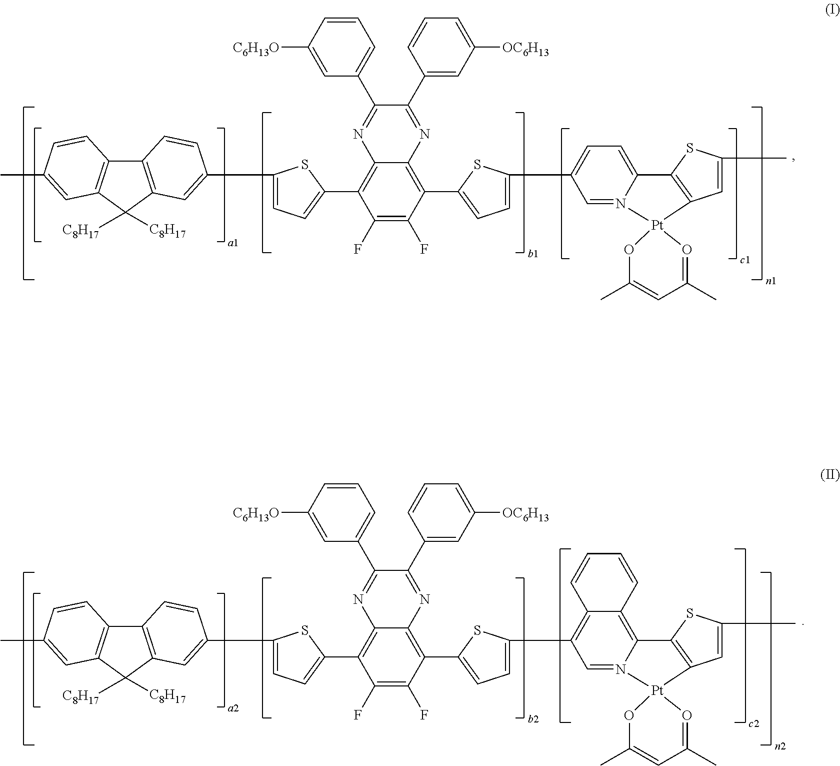

In the formula (I), a1≥0, b1≥0, a1+b1+c1=1, a1 and b1 are not 0 at the same time, and n1 is an integer of 1 to 100. In the formula (II), a2≥0, b2≥0, a2+b2+c2=1, a2 and b2 are not 0 at the same time, and n2 is an integer of 1 to 100. Alternatively, in the formula (I), a1=0.5, c1=0.05, 0.15 or 0.25, and b1=1-a1-c1. In the formula (II), a2=0.5, c2=0.05, 0.15 or 0.25, and b2=1-a2-c2.

The semiconductor compound can be further prepared into a semiconductor particle. For example, the semiconductor compound can be prepared into a particle diameter of the semiconductor particle is larger than 0 nm and less than or equal to 1000 μm.

### A Use of the Semiconductor Compound

A use of the semiconductor compound is provided of the present disclosure, the semiconductor compound can be used as a photocatalyst. When the semiconductor compound is applied to a hydrogen production system, the hydrogen production efficiency can be improved, and the increase of the toxicity of the solution system can be prevented, so as to meet the environmental requirement.

### A Hydrogen Production System

A hydrogen production system is provided of the present disclosure, the hydrogen production system includes the aforementioned semiconductor compound. The semiconductor compound has the photocatalytic activity. Therefore, the semiconductor compound is favorable for improving the efficiency of the hydrogen production system.

Specifically, the semiconductor compound of the present disclosure can be used as the photocatalyst for producing hydrogen, and the generated hydrogen gas can be used as the gas source of a fuel cell or other uses.

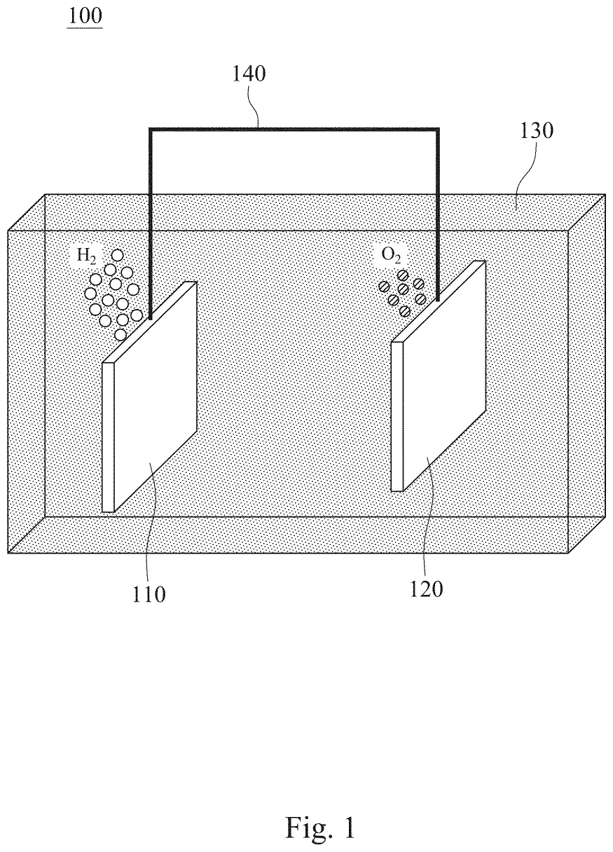

Please refer to FIG. 1, which is a schematic diagram of a hydrogen production system 100 according to one embodiment of the present disclosure. In FIG. 1, the hydrogen production system 100 is a photoelectrolytic hydrogen production system. The hydrogen production system 100 includes a cathode 110, an anode 120, a solution system 130 and a wire 140. The cathode 110 and the anode 120 are immersed in the solution system 130, and connected with the wire 140. The solution system 130 includes water. In one embodiment, the semiconductor compound can be dispersed in the solution system 130. In another embodiment, the semiconductor compound can be disposed on the cathode 110 and/or the anode 120. In addition, the semiconductor compound can be prepared to a form of the semiconductor particle. Therefore, when the light source (not shown) is provided, the hydrogen production system 100 can be performed a photocatalytic hydrogen evolution from water splitting. Due to the semiconductor compound of the present disclosure has the photocatalytic activity, which is favorable for improving the efficiency of the hydrogen production system 100. Furthermore, in the hydrogen production system 100, the type of the useable cathode 110, the type of the useable anode 120, or other additives that can be added to the solution system 130, such as a sacrificial electron donor, are not the focuses of the present disclosure and are generally known in the art, so that omitted.

### A Synthesis of Example/Comparative Example

The following reactions are all performed under a nitrogen atmosphere, and using the standard Schlenk techniques.

### Comparative Example 1 (COM1)

The semiconductor compound of COM1 includes a structure represented by formula (III):

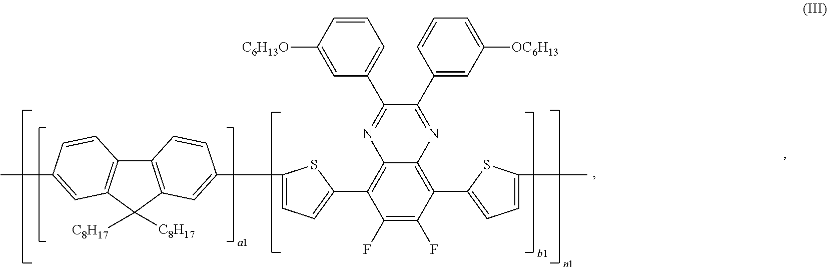

wherein, a1=0.5, b1=0.5, and is named as PFTFQ. The synthesis of PFTFQ is shown as follow. The raw materials of the polymerization reaction which are the monomer PF (161 mg, 0.25 mmol), the monomer TFQ (210 mg, 0.25 mmol), Na₂CO₃ (640 mg, 6.04 mmol), tetra-n-butylammonium bromide, TBAB (10.0 mg, 0.032 mmol) and Pd(PPh₃)₄ (10.0 mg, 0.008 mmol) placed in a sealed tube, then toluene and water are injected to the sealed tube to dissolve the aforementioned raw materials of the polymerization reaction to form a mixture. The mixture is purged with nitrogen for 30 minutes to remove the gas, and then heated to 80° C. for 72 hours. When the temperature is cooled to the room temperature, bromobenzene is added to the sealed tube, and heated to 80° C. for 6 hours. Subsequently, phenyl boronic acid is added to the sealed tube, and reacted at 80° C. for 6 hours. The mixture in the sealed tube is cooled to the room temperature and poured into methanol, the precipitate is collected by the membrane filtration method, and the precipitate is purified by the soxhlet extraction using methanol and hexane. Thereafter, the purified precipitate is dissolved in the hot chloroform (CHCl₃) to concentrate and poured into methanol to precipitate. Then, the precipitate is performed the vacuum drying, and the product of COM1 can be obtained. The molecular of the product of COM1 is measured by the gel permeation chromatography (GPC), and performed the analysis of the nuclear magnetic resonance (NMR, model: Bruker Avance 500 MHz NMR spectrometer). The results are shown as follows: GPC (THF): Mw 102.1 kg mol⁻¹ ; ¹HNMR (500 MHz, CDCl₃): δ 8.12 (br), 7.73-7.66 (m), 7.53 (br), 7.36-7.33 (m), 6.98 (br), 3.86(br), 2.08 (br), 1.66 (br), 1.35-1.08 (m), 0.88-0.73 (m). The analysis results are indicated that the product of COM1 is PFTFQ.

The synthesis reaction of COM1 is shown in Reaction Equation 1:

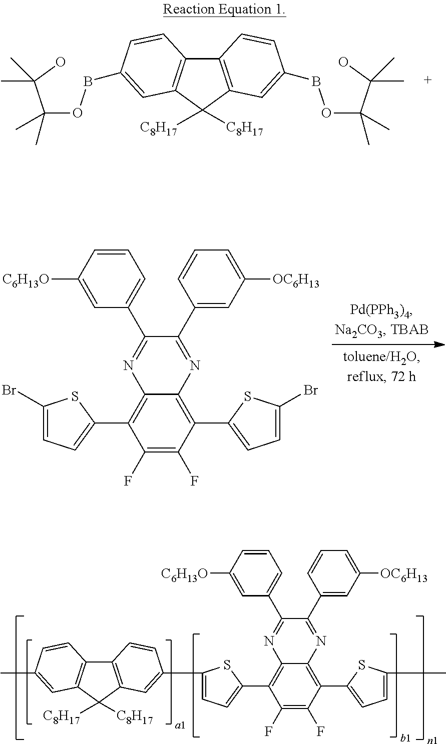

### Example 1 (EX1)

The semiconductor compound of EX1 includes a structure represented by formula (I), wherein, a1=0.5, b1=0.45, c1=0.05, and is named as PFTFQ-PtPy5. The formula (I) is as described in the above paragraph. Replace the raw materials of the polymerization reaction of COM1 as follows: the monomer PF (161 mg, 0.25 mmol), the monomer TFQ (189 mg, 0.225 mmol), the monomer PtPy (15.4 mg, 0.025 mmol), Na₂CO₃ (640 mg, 6.04 mmol), tetra-n-butylammonium bromide (10.0 mg, 0.032 mmol) and Pd(PPh₃)₄ (10.0 mg, 0.008 mmol), and other steps of EX1 are the same as that of COM1 so as to obtain the product of EX1. The molecular of the product of EX1 is measured by GPC, and performed the analysis of NMR. The results are shown as follows: GPC (THF): Mw 29.3 kg mol⁻¹; ¹H NMR (500 MHz, CDCl₃): δ 8.12 (br), 7.73-7.66 (m), 7.53 (br), 7.36-7.33 (m), 6.98 (br), 3.86 (br), 2.08 (br), 1.66 (br), 1.35-1.08 (m), 0.88-0.73 (m). The analysis results are indicated that the product of EX1 is PFTFQ-PtPy5.

### Example 2 (EX2)

The semiconductor compound of EX2 includes a structure represented by formula (I), wherein, a1=0.5, b1=0.35, c1=0.15, and is named as PFTFQ-PtPy15. Replace the raw materials of the polymerization reaction of COM1 as follows: the monomer PF (161 mg, 0.25 mmol), the monomer TFQ (147 mg, 0.175 mmol), the monomer PtPy (46 mg, 0.075 mmol), Na₂CO₃ (640 mg, 6.04 mmol), tetra-n-butylammonium bromide (10.0 mg, 0.032 mmol) and Pd(PPh₃)₄ (10.0 mg, 0.008 mmol), and other steps of EX2 are the same as that of COM1 so as to obtain the product of EX2. The molecular of the product of EX2 is measured by GPC, and performed the analysis of NMR. The results are shown as follows: Mw 21.1 kg mol⁻¹; ¹H NMR (500 MHz, CDCl₃): δ 8.12 (br), 7.73-7.66 (m), 7.53 (br), 7.36-7.33 (m), 6.98 (br), 3.86 (br), 2.08 (br), 1.66 (br), 1.35-1.08 (m), 0.88-0.73 (m). The analysis results are indicated that the product of EX2 is PFTFQ-PtPy15.

### Example 3 (EX3)

The semiconductor compound of EX3 includes a structure represented by formula (I), wherein, a1=0.5, b1=0.25, c1=0.25, and is named as PFTFQ-PtPy25. Replace the raw materials of the polymerization reaction of COM1 as follows: the monomer PF (161 mg, 0.25 mmol), the monomer TFQ (105 mg, 0.125 mmol), the monomer PtPy (76.6 mg, 0.125 mmol), Na₂CO₃ (640 mg, 6.04 mmol), tetra-n-butylammonium bromide (10.0 mg, 0.032 mmol) and Pd(PPh₃)₄ (10.0 mg, 0.008 mmol), and other steps of EX3 are the same as that of COM1 so as to obtain the product of EX3. The molecular of the product of EX3 is measured by GPC, and performed the analysis of NMR. The results are shown as follows: GPC (THF): Mw 18.0 kg mol⁻¹; ¹H NMR (500 MHz, CDCl₃): δ 8.12 (br), 7.73-7.66 (m), 7.53 (br), 7.36-7.33 (m), 6.98 (br), 3.86 (br), 2.08 (br), 1.66 (br), 1.35-1.08 (m), 0.88-0.73 (m). The analysis results are indicated that the product of EX3 is PFTFQ-PtPy25.

The synthesis reaction of EX1 to EX3 is shown in Reaction Equation 2:

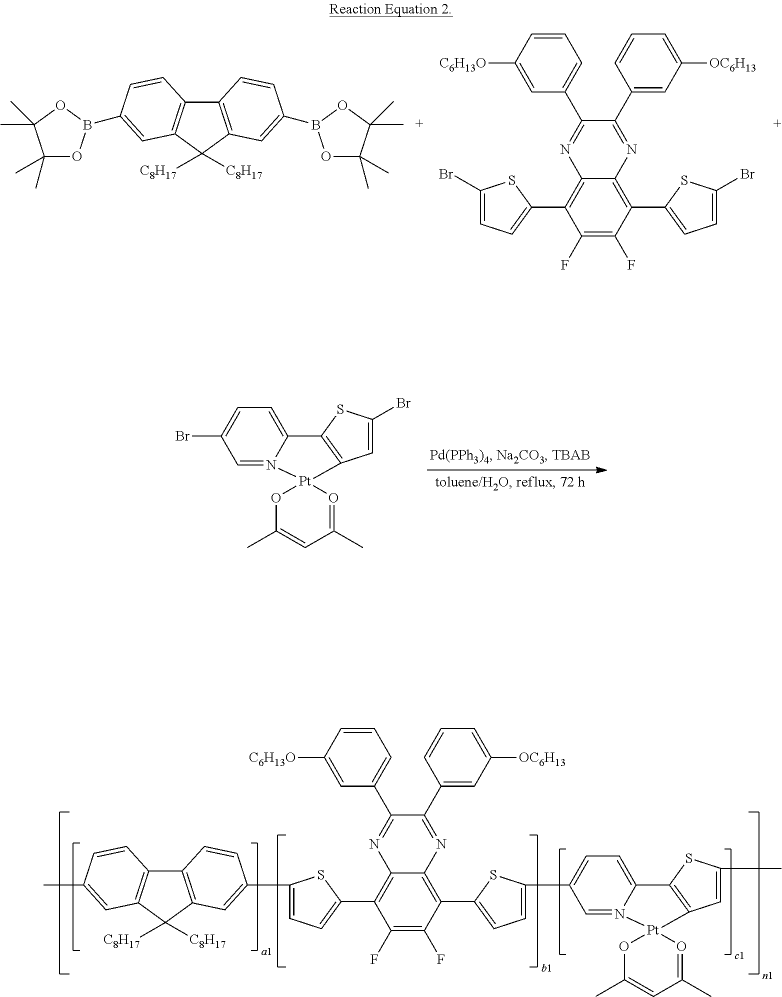

### Example 4 (EX4)

The semiconductor compound of EX4 includes a structure represented by formula (II), wherein, a2=0.5, b2=0.45, c2=0.05, and is named as PFTFQ-Ptlq5. The formula (II) is as described in the above paragraph. Replace the raw materials of the polymerization reaction of COM1 as follows: the monomer PF (161 mg, 0.25 mmol), the monomer TFQ (189 mg, 0.225 mmol), the monomer Ptlq (16.6 mg, 0.025 mmol), Na₂CO₃ (640 mg, 6.04 mmol), tetra-n-butylammonium bromide (10.0 mg, 0.032 mmol) and Pd(PPh₃)₄ (10.0 mg, 0.008 mmol), and other steps of EX4 are the same as that of COM1 so as to obtain the product of EX4. The molecular of the product of EX4 is measured by GPC, and performed the analysis of NMR. The results are shown as follows: GPC (THF): Mw 28.4 kg mol⁻¹; ¹H NMR (500 MHz, CDCl₃): δ 8.12 (br), 7.73-7.66 (m), 7.53 (br), 7.36-7.33 (m), 6.98 (br), 3.86 (br), 2.08 (br), 1.66 (br), 1.35-1.08 (m), 0.88-0.73 (m). The analysis results are indicated that the product of EX4 is PFTFQ-Ptlq5.

### Example 5 (EX5)

The semiconductor compound of EX5 includes a structure represented by formula (II), wherein, a2=0.5, b2=0.35, c2=0.15, and is named as PFTFQ-Ptlq15. Replace the raw materials of the polymerization reaction of COM1 as follows: the monomer PF (161 mg, 0.25 mmol), the monomer TFQ (147 mg, 0.175 mmol), the monomer Ptlq (49.6 mg, 0.075 mmol), Na₂CO₃ (640 mg, 6.04 mmol), tetra-n-butylammonium bromide (10.0 mg, 0.032 mmol) and Pd(PPh₃)₄ (10.0 mg, 0.008 mmol), and other steps of EX5 are the same as that of COM1 so as to obtain the product of EX5. The molecular of the product of EX5 is measured by GPC, and performed the analysis of NMR. The results are shown as follows: GPC (THF): Mw 20.4 kg mol⁻¹; ¹H NMR (500 MHz, CDCl₃): δ 8.12 (br), 7.73-7.66 (m), 7.53 (br), 7.36-7.33 (m), 6.98 (br), 3.86 (br), 2.08 (br), 1.66 (br), 1.35-1.08 (m), 0.88-0.73 (m). The analysis results are indicated that the product of EX5 is PFTFQ-Ptlq15.

### Example 6 (EX6)

The semiconductor compound of EX6 includes a structure represented by formula (II), wherein, a2=0.5, b2=0.25, c2=0.25, and is named as PFTFQ-Ptlq25. Replace the raw materials of the polymerization reaction of COM1 as follows: the monomer PF (161 mg, 0.25 mmol), the monomer TFQ (105 mg, 0.125 mmol), the monomer Ptlq (82.8 mg, 0.125 mmol), Na₂CO₃ (640 mg, 6.04 mmol), tetra-n-butylammonium bromide (10.0 mg, 0.032 mmol) and Pd(PPh₃)₄ (10.0 mg, 0.008 mmol), and other steps of EX6 are the same as that of COM1 so as to obtain the product of EX6. The molecular of the product of EX6 is measured by GPC, and performed the analysis of NMR. The results are shown as follows: GPC (THF): Mw 9.8 kg mol⁻¹; ¹H NMR (500 MHz, CDCl₃): δ 8.12 (br), 7.73-7.66 (m), 7.53 (br), 7.36-7.33 (m), 6.98 (br), 3.86 (br), 2.08 (br), 1.66 (br), 1.35-1.08 (m), 0.88-0.73 (m). The analysis results are indicated that the product of EX6 is PFTFQ-Ptlq25.

The synthesis reaction of EX4 to EX6 is shown in Reaction Equation 3:

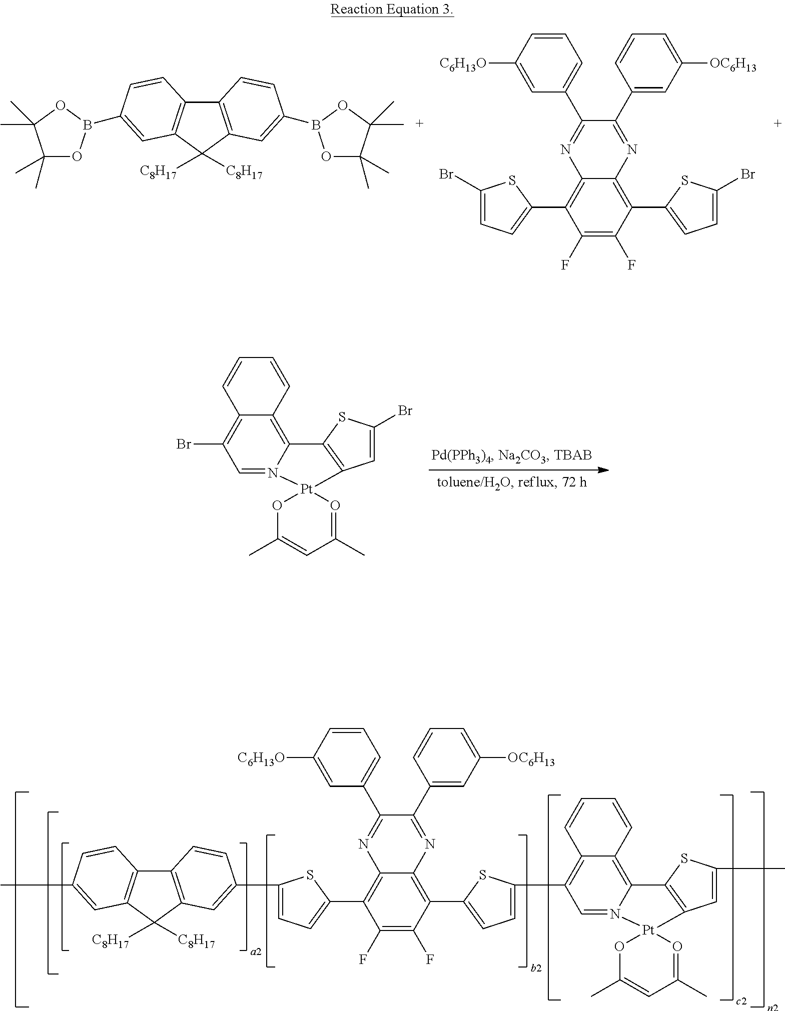

The full names of the aforementioned monomers are shown in Table 1.

TABLE 1

| Monomer | |
|---|---|
| abbreviation | Full name of the monomer |
| PF | 2,7-dibromo-9,9′-dioctyl-9H-fluorene |
| TFQ | 5,8-bis(5-bromothiophen-2-yl)-6,7-difluoro- |
| | 2,3-bis(3-(hexyloxy)phenyl)quinoxaline |
| PtPy | platinum(II)(5-bromo-2-(5-bromothiophen- |
| | 2-yl)pyridinato-N,C3′) |
| | (2,4-pentane-dionato-O,O) |
| PtIq | platinum(II)(4-bromo-1-(5-bromothiophen- |
| | 2-yl)isoquinolinato-N,C3′) |
| | (2,4-pentanedionato-O,O) |

The semiconductor compound of the present disclosure can be prepared to the semiconductor particle.

The preparation method of the semiconductor particle is as follows. (1) Providing a polymer solution, wherein the semiconductor compound is dissolved in a first solvent so as to form a first solution. (2) Providing a second solution, wherein an amphiphilic molecule is dissolved in a second solvent so as to form the second solution. The first solvent and the second solvent can be the same or different, as long as both of the solvent can be miscible each other and not performed the chemical reaction, wherein the amphiphilic molecule includes a hydrophilic end and an oleophilic end. (3) Performing a mixing and disturbancing step, wherein the first solution and the second solution are mixed to pour into ultrasonically disturbed water, so as to form a mixing solution. (4) Performing a solvent removing step, wherein the mixing solution is heated under the nitrogen condition so as to remove the first solvent and the second solvent. (5) Performing a filtrating step, wherein the precipitate is taken to obtain the semiconductor particle. Therefore, in the semiconductor particle, the semiconductor compound is coated by the amphiphilic molecule. The amphiphilic molecule is adsorbed to the semiconductor compound by the oleophilic end, and the hydrophilic end can help the semiconductor particle dispersed in the aqueous solution system. For example, when the semiconductor particle of the present disclosure is used as a catalyst for hydrogen evolution from water splitting, an organic solvent, such as methanol, is not required to add additionally to improve the dispersibility of the semiconductor particle, which is favorable for reducing the use of the organic solvent and further reducing the toxicity of the solution system.

The aforementioned amphiphilic molecule is not particularly limited, as long as the amphiphilic molecule includes the hydrophilic end and the oleophilic end, and not detracts from the photocatalytic activity of the semiconductor particle. For example, the amphiphilic molecule can be but is not limited to PS-PEG-COOH (can be purchased form Polymer Source, MW:21700 Da of the PS moiety' 1200 Da of PEG-COOH).

Specifically, the semiconductor compound of COM1, EX1 to EX6 can be adopted the following preparation method respectively to prepare the semiconductor particle. The semiconductor compound is dissolved in tetrahydrofuran to form the first solution (1 mg mL⁻¹ in THF, 800 μL), and the amphiphilic molecule PS-PEG-COOH is dissolved in tetrahydrofuran to form the second solution (1 mg mL⁻¹ in THF, 600 μL), then the first solution, the second solution and tetrahydrofuran (5 mL) are mixed to pour into ultrasonically disturbed water (10 mL) quickly, so as to form a mixing solution. Thereafter, the mixing solution is heated under the nitrogen condition so as to remove tetrahydrofuran. The mixing solution can be heated at a temperature of about 96° C. for 60 minutes, and filtered by a 0.45 μm cellulose membrane, so as to obtain the semiconductor particle.

### The Physical Property Measurement of Example/Comparative Example

The semiconductor compound and the semiconductor particle of COM1, EX1 to EX6 are performed the following physical property measurement.

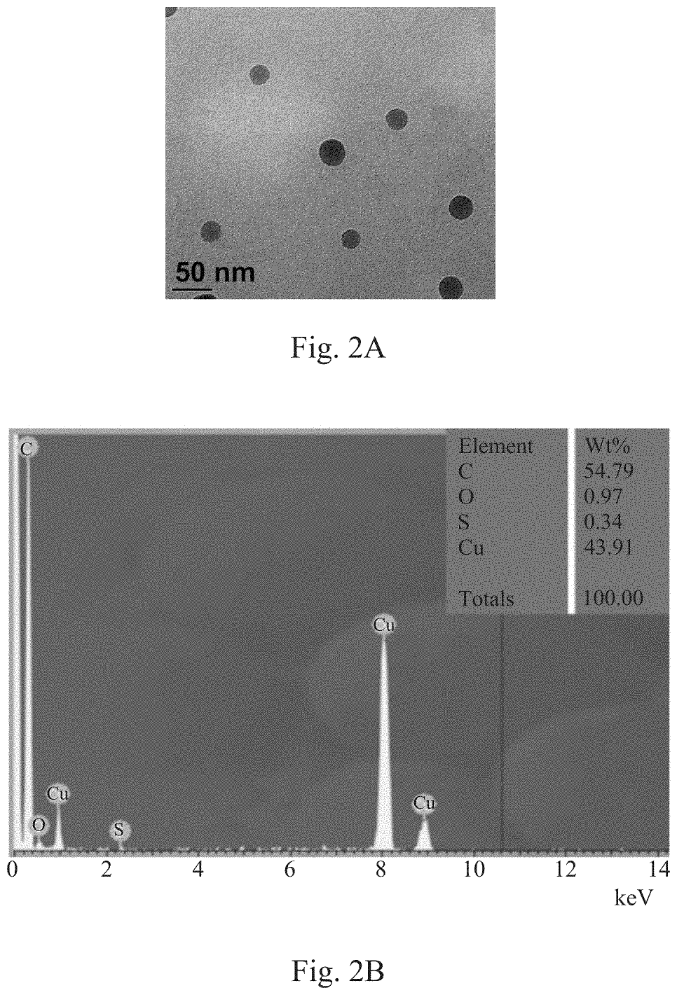

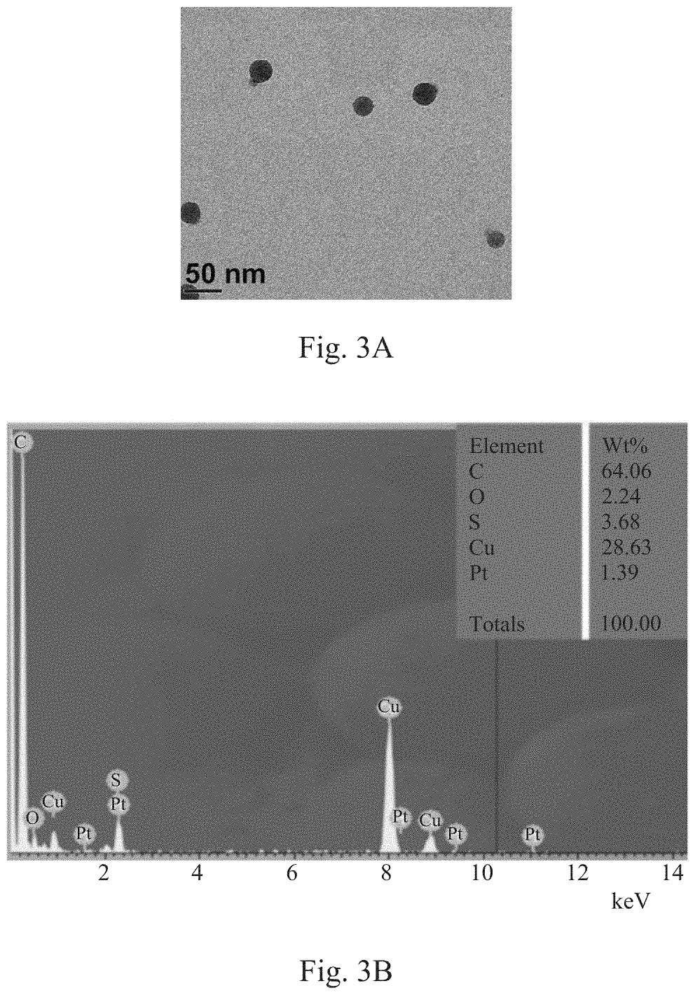

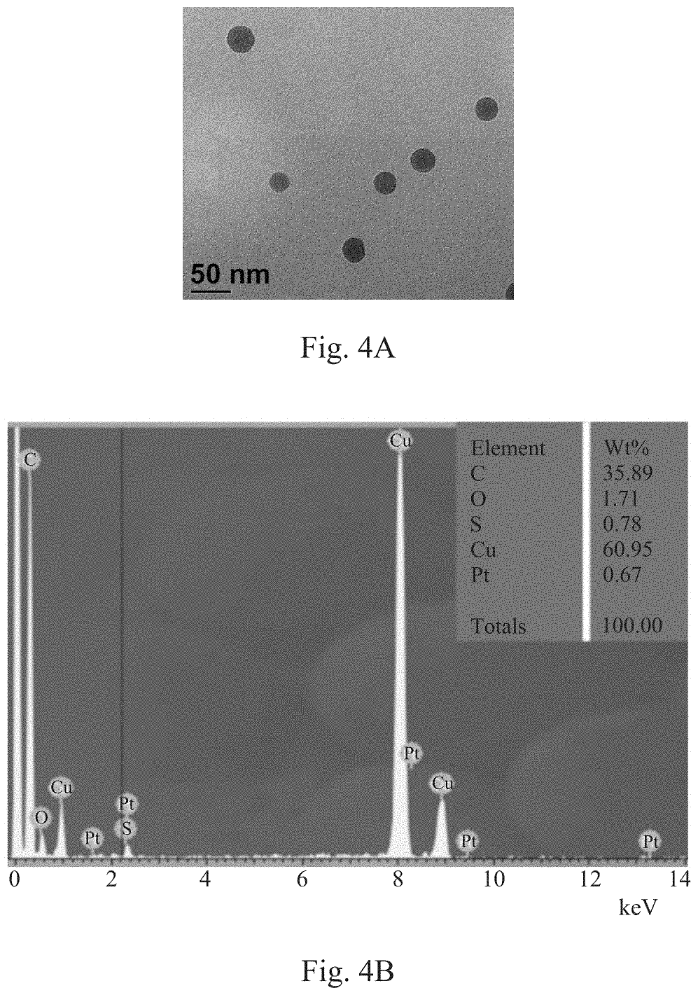

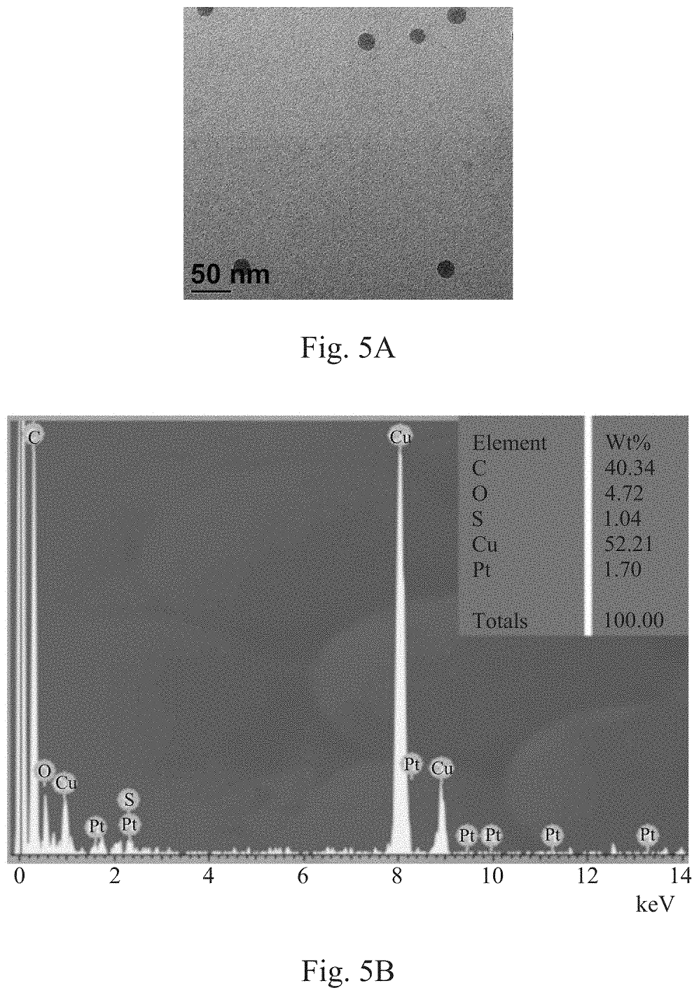

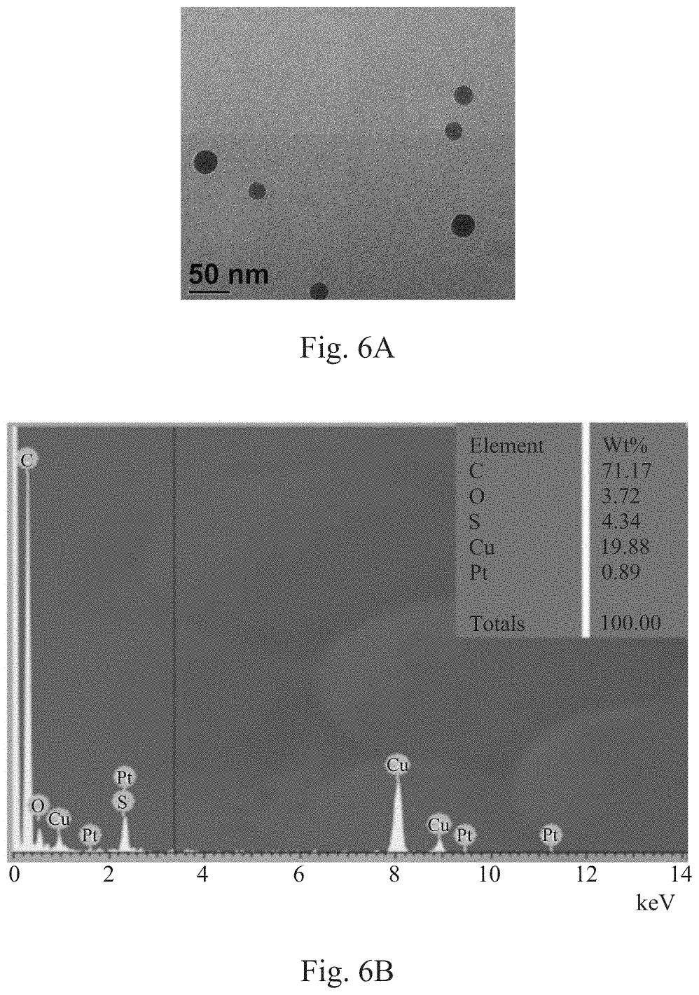

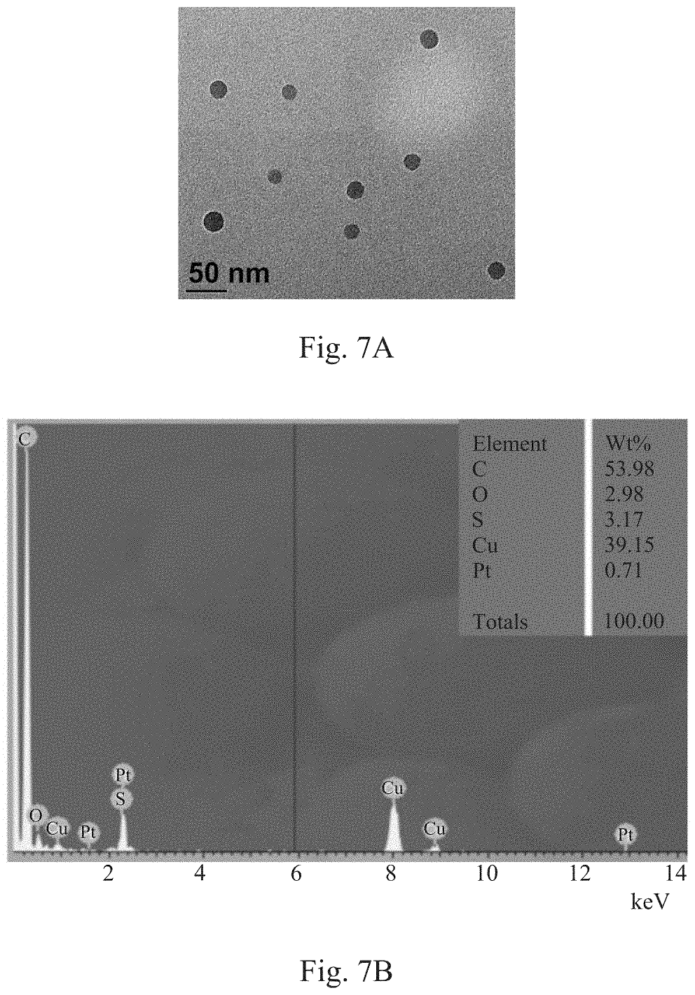

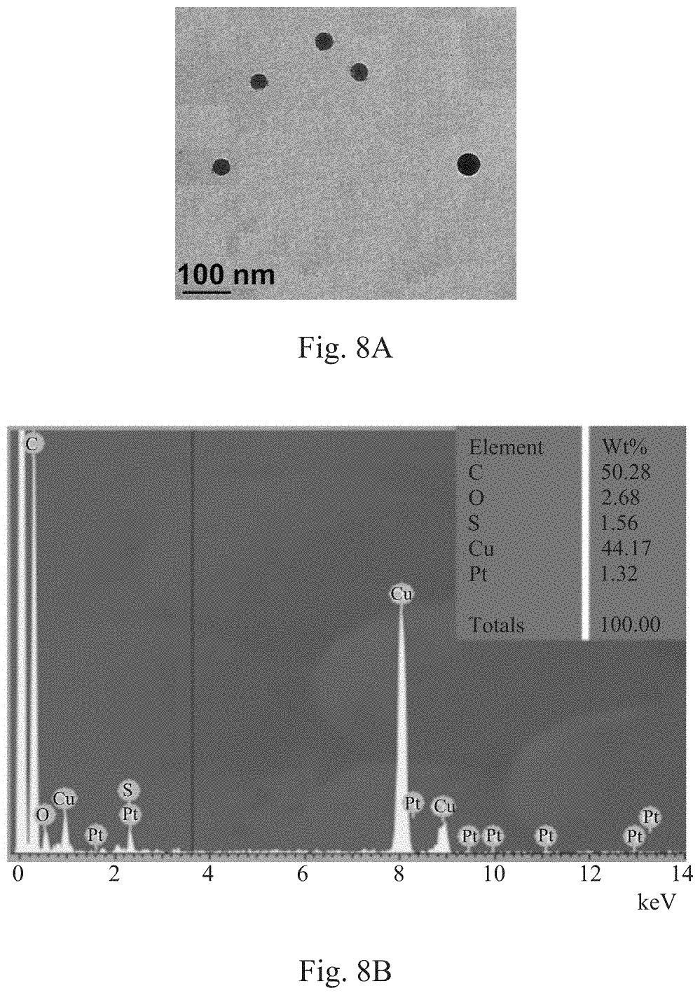

(1) The semiconductor particle of COM1, EX1 to EX6 is measured by using Transmission Electron Microscopy (TEM, model is JEOL 2100) and Energy-Dispersive X-ray spectrometer (EDX). Please refer to FIG. 2A to FIG. 8B, wherein FIG. 2A is a TEM image of the semiconductor particle of COM1. FIG. 2B is an EDX image of the semiconductor particle of COM1. FIG. 3A is a TEM image of the semiconductor particle of EX1. FIG. 3B is an EDX image of the semiconductor particle of EX1. FIG. 4A is a TEM image of the semiconductor particle of EX2. FIG. 4B is an EDX image of the semiconductor particle of EX2. FIG. 5A is a TEM image of the semiconductor particle of EX3. FIG. 5B is an EDX image of the semiconductor particle of EX3. FIG. 6A is a TEM image of the semiconductor particle of EX4. FIG. 6B is an EDX image of the semiconductor particle of EX4. FIG. 7A is a TEM image of the semiconductor particle of EX5. FIG. 7B is an EDX image of the semiconductor particle of EX5. FIG. 8A is a TEM image of the semiconductor particle of EX6. FIG. 8B is an EDX image of the semiconductor particle of EX6. The results of the TEM measurement can indicate that the semiconductor compound of COM1, EX1 to EX6 is successfully prepared to the semiconductor particle, respectively. In addition, the content of Pt in EX1 to EX6 can be seen from the result of the EDX measurement, and can be seen that the metal complex unit is introduced to the conjugate unit successfully by EX1 to EX6 to synthesize the semiconductor compound/the semiconductor particle of the present disclosure.

(2) The particle size of the semiconductor particle: The hydrodynamic diameter of the semiconductor particle of COM1, EX1 to EX6 is measured by Dynamic Light Scattering (DLS). In Table 2, the hydrodynamic diameter is referred to as a diameter. The measuring instrument is Zetasizer Nano ZS90 (Malvern Instruments Nordic AB). The results are recorded in Table 2.

(3) The weight average molecular weight (Mw), the number average molecular weight (Mn): The semiconductor compound of COM1, EX1 to EX6 is measured by GPC at 40° C., the mobile phase is tetrahydrofuran (the flow rate is 1 mL min⁻¹), and using polystyrene standards, so as to obtain Mw and Mn. The polymer dispersity index (PDI) is calculated by the measurement results of Mw and Mn, and PDI=Mw/Mn. The results are recorded in Table 2.

(4) Thermogravimetric analysis (TGA): The semiconductor compound of COM1, EX1 to EX6 is measured by the thermogravimetric analyzer (model: TA Q600) at the nitrogen condition, the heating rate is 10° C. min⁻¹, and the temperature ranges from 50° C. to 650° C., so as to obtain the degradation temperature (T_{d}). The results are recorded in Table 2.

TABLE 2

| | diameter (nm) | Mw | Mn | PDI | T_{d}(° C.) |
|---|---|---|---|---|---|
| COM1 | 45.11 | 102072 | 39284 | 2.60 | 431 |
| EX1 | 68.36 | 29333 | 13833 | 2.12 | 414 |
| EX2 | 80.20 | 21084 | 5353 | 3.94 | 346 |
| EX3 | 48.04 | 18021 | 4920 | 3.66 | 355 |
| EX4 | 45.29 | 28391 | 7347 | 3.86 | 421 |
| EX5 | 82.17 | 20367 | 9149 | 2.23 | 416 |
| EX6 | 40.29 | 9821 | 6286 | 1.56 | 395 |

As shown in Table 2, the particle size of the semiconductor particle is ranged from 40 nm to 80 nm. As the proportion of the metal complex unit in the semiconductor compound increases, the weight average molecular weight and the number average molecular weight will decrease. The semiconductor compound has the excellent thermal stability.

### The Photophysical Property Measurement of Example/Comparative Example

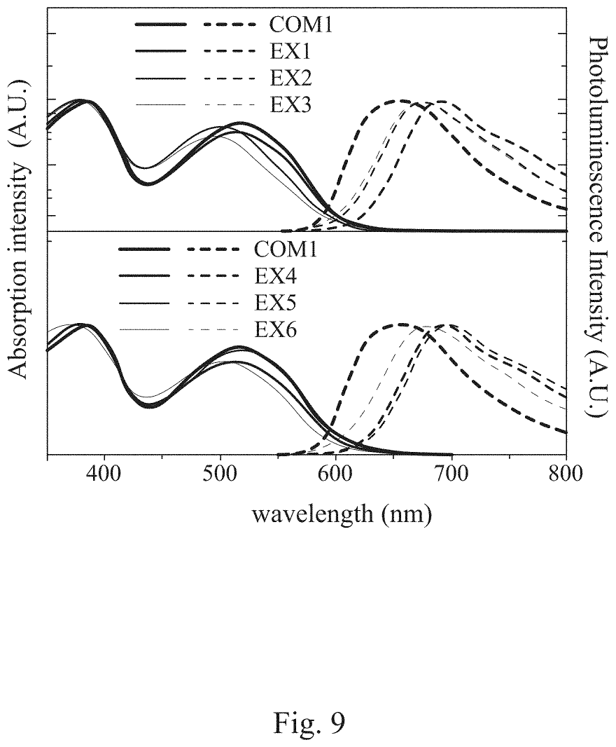

The semiconductor particle of COM1, EX1 to EX6 is dispersed in water, measuring the UV-Vis absorption spectrum and the photoluminescence spectrum to estimate the Stokes shift and the optical bandgap (E_{g}). The optical bandgap is 1241/λₒₙₛₑₜ. The measuring instrument of the UV-Vis absorption spectrum is Hitachi U-3300 spectrometer and Dynamica HALO DB-20S spectrometer. The measuring instrument of the photoluminescence spectrum is Hitachi F-7000 spectrometer, the excitation wavelength is 510 nm, and is performed at the room temperature. Please refer to FIG. 9, which is a UV-Vis absorption spectrum and a photoluminescence spectrum of the semiconductor particle of COM1, EX1 to EX6, wherein the lines of the same embodiment have the same thickness. The solid line indicates that the UV-Vis absorption spectrum. The dashed line indicates that the photoluminescence spectrum. The results of the wavelength (λ_{Absmax}) corresponding to the maximum value of the absorption peak, the wavelength (λ_{PLmax}) corresponding to the maximum value of the photoluminescence peak, the Stokes shift and the optical bandgap of COM1, EX1 to EX6 are shown in Table 3.

The semiconductor particle of COM1, EX1 to EX6 is used a photoelectron spectrometer (model: AC-2) to measure the HOMO energy level. The LUMO energy level is the difference obtained by subtracting the optical bandgap from the HOMO energy level. The obtained HOMO energy level and LUMO energy level are shown in Table 3.

The semiconductor particle of COM1, EX1 to EX6 is performed the measurement of time-resolved transient photoluminescence decay spectra. The semiconductor particle is added to 10 mL of diethylamine (DEA), so that the concentration of the semiconductor particle is 20 vol %, and using a light emitting diode lamp (λ>420 nm, 20 W, 6500K) as the light source to measure. The lifetime of the semiconductor particle of COM1, EX1 to EX6 is shown in Table 3.

TABLE 3

| | | | | HOMO | LUMO | | |
|---|---|---|---|---|---|---|---|
| | | | Stokes | energy | energy | | Life- |
| | λ_{Absmax} | λ_{PLmax} | shift | level | level | E_{g} | time |
| | (nm) | (nm) | (nm) | (eV) | (eV) | (eV) | (ns) |
| COM1 | 384, 517 | 664 | 147 | −5.60 | −3.57 | 2.03 | 1.57 |
| EX1 | 381, 516 | 690 | 174 | −5.67 | −3.65 | 2.02 | 0.90 |
| EX2 | 383, 509 | 686 | 177 | −5.64 | −3.61 | 2.03 | 0.79 |
| EX3 | 373, 496 | 673 | 177 | −5.69 | −3.67 | 2.02 | 0.67 |
| EX4 | 380, 512 | 692 | 180 | −5.62 | −3.61 | 2.01 | 0.89 |
| EX5 | 380, 519 | 697 | 178 | −5.60 | −3.59 | 2.01 | 0.67 |
| EX6 | 372, 504 | 678 | 174 | −5.69 | −3.66 | 2.03 | 0.60 |

As shown in Table 3, EX1 to EX6 have the shorter lifetime than COM1, indicating that the metal complex unit is favorable for transporting charge to increase the catalytic activity of the semiconductor particle.

### The Photocatalytic Property Measurement of Example/Comparative Example

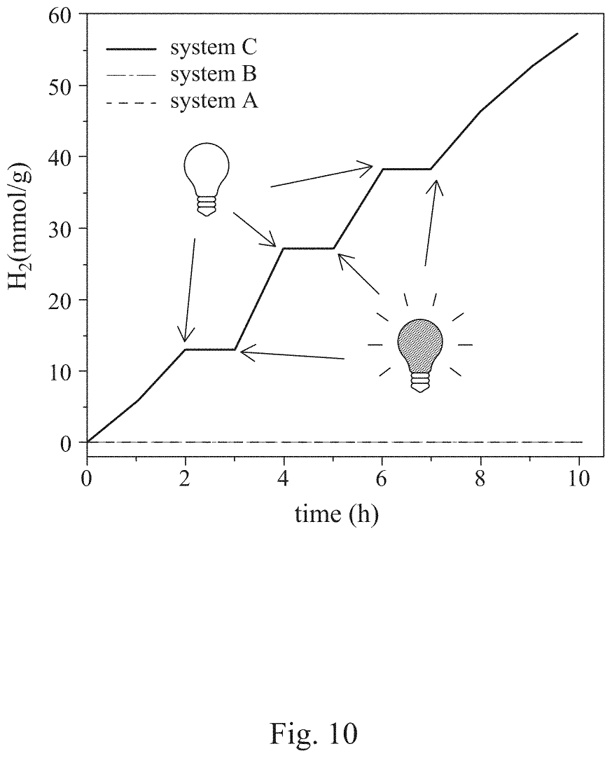

The measurement method of the photocatalytic property is as follows: using the light emitting diode lamp (model: LED PAR30; 20 W, 6500 K, λ>420 nm) as the light source, and the experimental water is performed the purification by the purification instrument (model: ELGA Lab Water system) first. Observing the effect of the photocatalytic hydrogen evolution from water splitting as following three systems. System A is to add DEA to water, and the photocatalytic hydrogen evolution from water splitting is performed under the illumination condition. System B is to add the semiconductor particle of EX2 to water, and the photocatalytic hydrogen evolution from water splitting is performed under the illumination condition. System C is to add the semiconductor particle of EX2 and DEA to water, and the photocatalytic hydrogen evolution from water splitting is performed under the illumination condition. DEA is used as the sacrificial electron donor. Please refer to FIG. 10, which is a result diagram of the photocatalytic hydrogen evolution from water splitting of system A, system B and system C. Specifically, FIG. 10 is a graph of the relationship between the hydrogen production obtained by photocatalytic hydrogen evolution from water splitting of system A, system B and system C and time. The vertical coordinate is representative of hydrogen production, and the unit is mmol g⁻¹ (mmole of hydrogen gas produced per gram of photocatalyst). The horizontal coordinate is representative of time, and the unit is hour. In addition, the upper bulb symbol represents when the light source is turned off, and the lower bulb symbol represents when the light source is turned on. As known in FIG. 10, the results of system A and system B are overlapped, which is a horizontal line of hydrogen production equal to 0, and indicating that the hydrogen production of system A and system B is 0 whether the light source is turned on or turned off. That is, only DEA or only the semiconductor particle of EX2 cannot provide the catalytic activity of hydrogen evolution from water splitting. In contrast, system C contains both DEA and the semiconductor particle of EX2. When the light source is turned off, the hydrogen production of system C stops increasing, and when the light source is turned on, the hydrogen production of system C rises. That is, the semiconductor particle of EX2 can exert the catalytic activity of hydrogen evolution from water splitting under the presence of the sacrificial electron donor. It is generally known in the art that when the hydrogen evolution from water splitting, adding the sacrificial electron donor so that the catalyst for hydrogen evolution from water splitting exerts the catalytic, and it is not described in detail herein. As shown in FIG. 10, the semiconductor particle of the present disclosure has the photocatalytic activity, which can be induced by the suitable conditions (for example, it can be but is not limited to illumination, providing the sacrificial electron donor), and can be used as the photocatalytic.

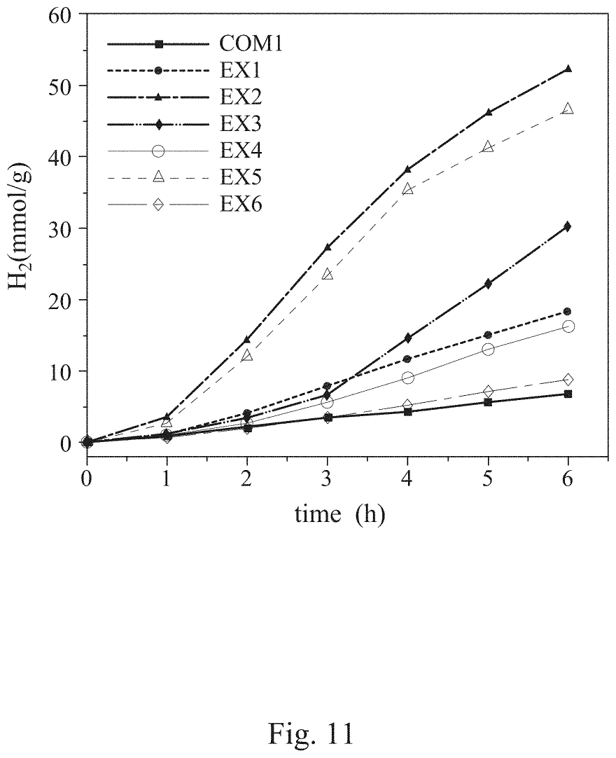

The semiconductor particle of COM1, EX1 to EX6 is performed the photocatalytic hydrogen evolution from water splitting experiment, and the experiment method is as follows. The light emitting diode lamp (model: LED PAR30 ; 20 W ‘6500 K’ λ>420 nm) is used as the light source. The semiconductor particle of COM1, EX1 to EX6 is placed in the solution containing DEA, respectively, and the concentration of the semiconductor particle of COM1, EX1 to EX6 is 5 mg/10 mL of the DEA solution, the concentration of DEA is 20%. The relationship between the hydrogen production and time is measured by gas chromatography (GC) so as to obtain the hydrogen evolution rate (HER), and the average HER in 4 hours can be calculated. The results are recorded in Table 4. Please refer to FIG. 11, which is a result diagram of the photocatalytic hydrogen evolution from water splitting of the semiconductor particle of COM1, EX1 to EX6. As shown in FIG. 11, EX1 to EX6 has better photocatalytic hydrogen evolution from water splitting effect than that of COM1, and the effect of EX2 and EX5 is the best. The HER of EX2 is 12.7±0.6 mmolh⁻¹g⁻¹, the HER of COM1 is 1.3±0.1 mmolh⁻¹g⁻¹, and the HER of EX2 is about 12 times than that of COM1. In addition, as shown in FIG. 11, the average HER of EX2 and EX5 in 4 hours is 10.2±0.3 mmolh⁻¹g⁻¹ and 9.3±0.3 mmolh⁻¹g⁻¹, respectively. That is, from the first hour to the fifth hour, the roll-off of HER is only 16% to 19%, indicating that when the semiconductor particle of the present disclosure is used as the photocatalyst can provide the catalytic performance for long-lasting.

TABLE 4

| | HER | 4-h average of HER |
|---|---|---|
| | (mmol h⁻¹ g⁻¹) | (mmol h⁻¹g⁻¹) |
| COM1 | 1.3 ± 0.1 | 1.1 ± 0.1 |
| EX1 | 4.1 ± 0.1 | 3.5 ± 0.1 |
| EX2 | 12.7 ± 0.6 | 10.2 ± 0.3 |
| EX3 | 7.7 ± 0.2 | 4.9 ± 0.5 |
| EX4 | 4.2 ± 0.1 | 3.2 ± 0.1 |
| EX5 | 11.1 ± 0.3 | 9.3 ± 0.3 |
| EX6 | 1.6 ± 0.2 | 1.5 ± 0.1 |

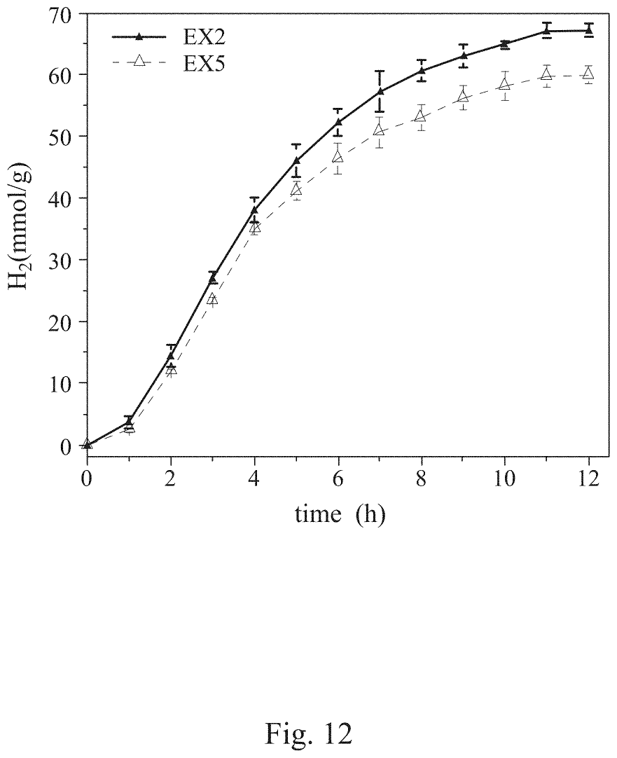

The semiconductor particle of EX2 and EX5 is performed another photocatalytic hydrogen evolution from water splitting experiment, and the method as above, but the time is extended to 12 hours. Please refer to FIG. 12, which is a result diagram of the photocatalytic hydrogen evolution from water splitting of the semiconductor particle of EX2 and EX5. As shown in FIG. 12, the catalytic activity of the semiconductor particle of EX2 and EX5 can last for 12 hours, and the hydrogen production amount of EX2 and EX5 in 12 hours is 66.3±1.0 mmolh⁻¹g⁻¹ and 59.8 mmolh⁻¹g⁻¹, respectively. It is indicates that when the semiconductor particle of the present disclosure is used as the photocatalyst can provide the catalytic performance for long-lasting and the excellent hydrogen production.

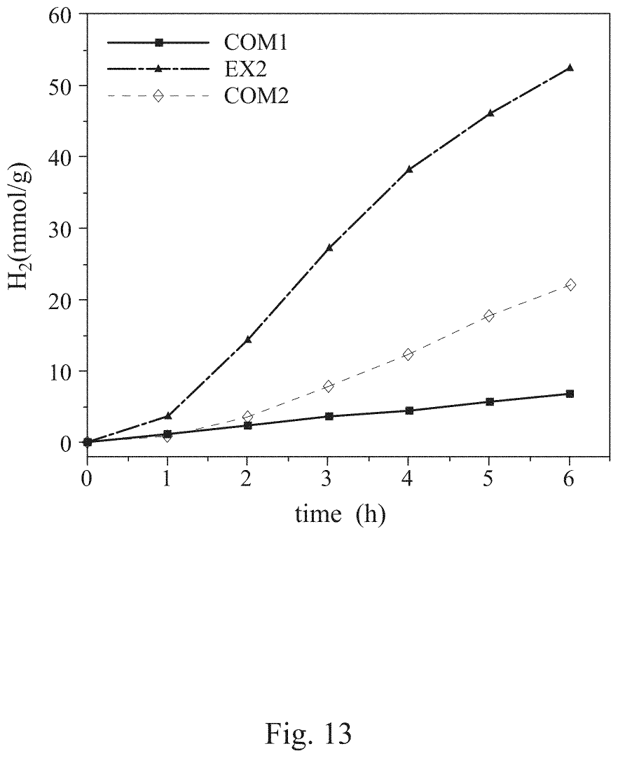

The semiconductor particle of COM1, EX2 and Comparative Example 2 (COM2) is performed another photocatalytic hydrogen evolution from water splitting experiment, wherein COM2 is the semiconductor particle which is prepared by the monomer (PtPy) providing the metal complex unit and the semiconductor compound of COM1 to perform the physical mixing. The difference between EX2 and COM2 is that the metal complex unit and the conjugate unit of EX2 are linked by the covalent bond, and the metal complex unit and the conjugate unit of COM2 are physical mixed without the covalent bond connection. Please refer to FIG. 13, which is a result diagram of the photocatalytic hydrogen evolution from water splitting of the semiconductor particle of COM1, EX2 and COM2. As shown in FIG. 13, EX2 has better photocatalytic hydrogen evolution from water splitting effect than that of COM1 and COM2, indicating that the metal complex unit is linked with the conjugate unit by the covalent bond of the present disclosure is favorable for increasing the photocatalytic activity.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

1. A semiconductor compound, comprising:
a metal complex unit, comprising:
a coordination center, wherein the coordination center is a metal ion or a metal atom; and
a plurality of ligands, wherein the ligands are linked with the coordination center; and
a conjugate unit, wherein the conjugate unit is linked with the metal complex unit by covalent bond.

2. The semiconductor compound of claim 1, wherein a coordination number of the metal complex unit is four or six.

3. The semiconductor compound of claim 1, wherein the coordination center is platinum, zinc, cobalt, nickel, iron, copper, ruthenium, rhodium, iridium, palladium, platinum ion, zinc ion, cobalt ion, nickel ion, iron ion, copper ion, ruthenium ion, rhodium ion, iridium ion or palladium ion.

4. The semiconductor compound of claim 1, wherein each of the ligands is a bidentate ligand, and the bidentate ligand is linked to the coordination center by two nitrogen atoms, two carbon atoms, a nitrogen atom and a carbon atom or two oxygen atoms.

5. The semiconductor compound of claim 1, wherein each of the ligands comprises a structure represented by formula (i-1), formula (i-2), formula (i-3) or formula (i-4), wherein the ligand is linked to the coordination center by a carbon atom, a nitrogen atom or an oxygen ion with * : 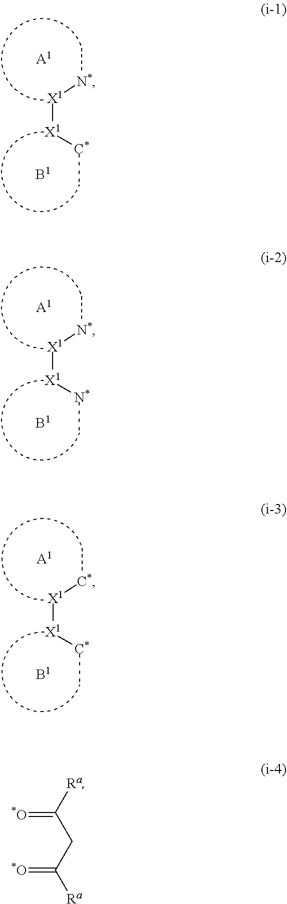
wherein each X¹ is independently the carbon atom or the nitrogen atom, each R^{a} is independently a hydrogen atom, a deuterium atom, a halogen atom or a monovalent group, each A¹ is independently a substituted or an unsubstituted divalent nitrogen-containing heterocycle, each B¹ is independently a substituted or an unsubstituted divalent organic ring containing an unsaturated bond.

6. The semiconductor compound of claim 5, wherein the monovalent group is a hydroxyl group, a cyano group, a nitro group, a substituted or an unsubstituted amino group, an amide group, a hydrazine group, a hydrazine group, a carboxyl group or a salt thereof, a sulfonic acid group or a salt thereof, a phosphoric acid group or a salt thereof, a substituted or an unsubstituted alkyl group of 1 to 60 carbon atoms, a substituted or an unsubstituted alkenyl group of 2 to 60 carbon atoms, a substituted or an unsubstituted alkynyl group of 2 to 60 carbon atoms, a substituted or an unsubstituted alkoxy group of 1 to 60 carbon atoms, a substituted or an unsubstituted cycloalkyl group of 3 to 10 carbon atoms, a substituted or an unsubstituted cycloalkenyl group of 3 to 10 carbon atoms, a substituted or an unsubstituted heterocycloalkyl group of 3 to 10 carbon atoms, a substituted or an unsubstituted heterocycloalkenyl group of 3 to 10 atoms, a substituted or an unsubstituted aryl group of 6 to 30 carbon atoms, a substituted or an unsubstituted aryloxy group of 6 to 30 carbon atoms, a substituted or an unsubstituted arylthio group of 6 to 30 carbon atoms, a substituted or an unsubstituted heteroaryl group of 2 to 30 carbon atoms, a substituted or an unsubstituted aldehyde group or a substituted or an unsubstituted silyl group.

7. The semiconductor compound of claim 5, wherein the divalent nitrogen-containing heterocycle is pyrrol, imidazole, pyrazole, triazole, thiazole, oxazole, isothiazole, isoxazole, benzothiazole, benzoimidazole, benzooxazole, pyridine, pyrazine, pyrimidine, pyridazine, isoindole, indole, indazole, purine, isoquinoline, quinoline, phthalazine, naphthyridine, quinoxaline, quinazoline, cinnoline, phenanthridine, acridine, phenanthroline or phenoxazine.

8. The semiconductor compound of claim 5, wherein the divalent organic ring is benzene, pentalene, indene, naphthalene, azulene, heptalene, indacene, acenaphthylene, fluorene, spiro-fluorene, phenalene, phenanthrene, anthracene, fluoranthene, triphenylene, pyrene, chrysene, thiophene, pyrrol, imidazole, pyrazole, triazole, thiazole, oxazole, isothiazole, isoxazole, benzothiazole, benzoimidazole, benzooxazole, pyridine, pyrazine, pyrimidine, pyridazine, isoindole, indole, indazole, purine, isoquinoline, quinoline, phthalazine, naphthyridine, quinoxaline, quinazoline, cinnoline, phenanthridine, acridine, phenanthroline or phenoxazine.

9. The semiconductor compound of claim 1, wherein the conjugate unit is an electron donor, an electron acceptor or a combination of the electron donor and the electron acceptor.

10. The semiconductor compound of claim 1, wherein the conjugate unit comprises a structure represented by formula (ii-1), formula (ii-2), formula (ii-3), formula (ii-4), formula (ii-5), formula (ii-6), formula (ii-7), formula (ii-8), formula (ii-9), formula (ii-10) or formula (ii-11): 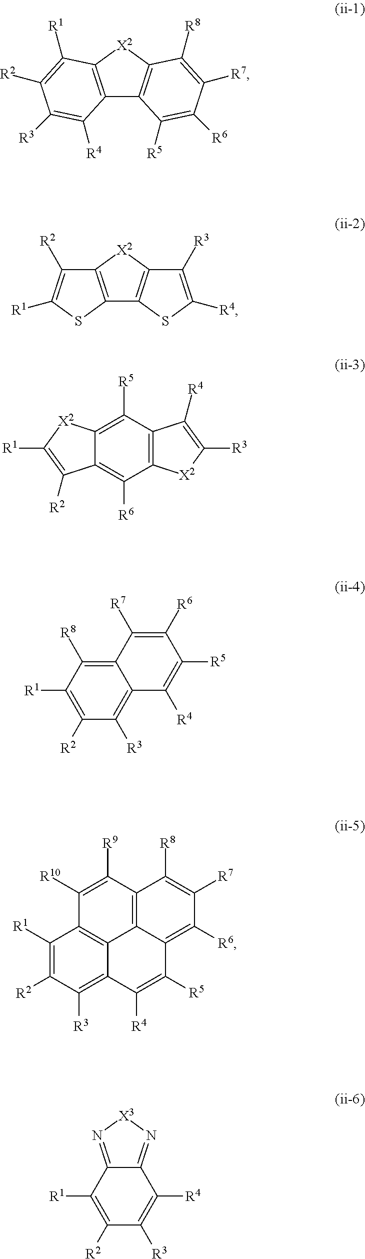 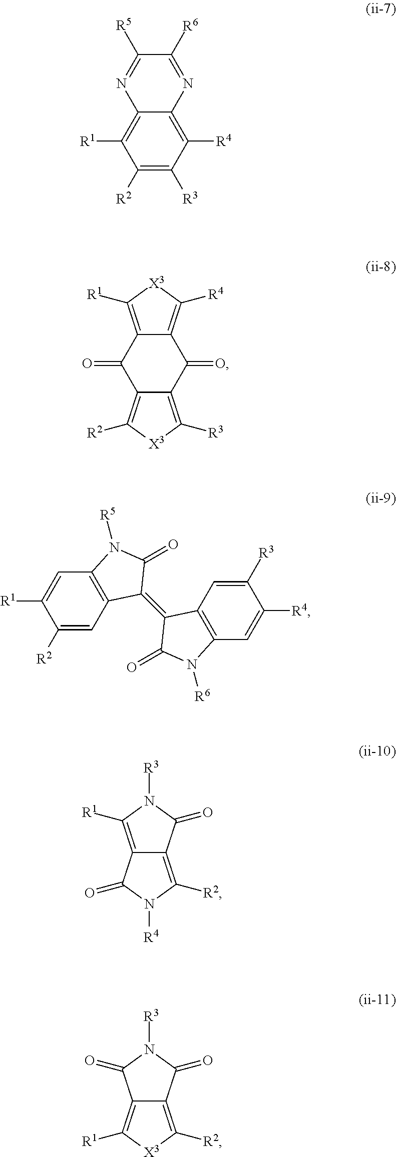
wherein each X² is independently S, Se, C(R¹¹)(R¹²), N(R¹³) or Si(R¹⁴)(R^{15,})each X³ is independently S, O, Se or N(R¹³), R¹ to R¹⁵ are each independently the hydrogen atom, the deuterium atom, the halogen atom or the monovalent group.

11. The semiconductor compound of claim 10, wherein the monovalent group is a hydroxyl group, a cyano group, a nitro group, a substituted or an unsubstituted amino group, an amide group, a hydrazine group, a hydrazine group, a carboxyl group or a salt thereof, a sulfonic acid group or a salt thereof, a phosphoric acid group or a salt thereof, a substituted or an unsubstituted alkyl group of 1 to 60 carbon atoms, a substituted or an unsubstituted alkenyl group of 2 to 60 carbon atoms, a substituted or an unsubstituted alkynyl group of 2 to 60 carbon atoms, a substituted or an unsubstituted alkoxy group of 1 to 60 carbon atoms, a substituted or an unsubstituted cycloalkyl group of 3 to 10 carbon atoms, a substituted or an unsubstituted cycloalkenyl group of 3 to 10 carbon atoms, a substituted or an unsubstituted heterocycloalkyl group of 3 to 10 carbon atoms, a substituted or an unsubstituted heterocycloalkenyl group of 3 to 10 atoms, a substituted or an unsubstituted aryl group of 6 to 30 carbon atoms, a substituted or an unsubstituted aryloxy group of 6 to 30 carbon atoms, a substituted or an unsubstituted arylthio group of 6 to 30 carbon atoms, a substituted or an unsubstituted heteroaryl group of 2 to 30 carbon atoms, a substituted or an unsubstituted aldehyde group or a substituted or an unsubstituted silyl group.

12. The semiconductor compound of claim 1, wherein the semiconductor compound comprises a structure represented by formula (I) or formula (II): 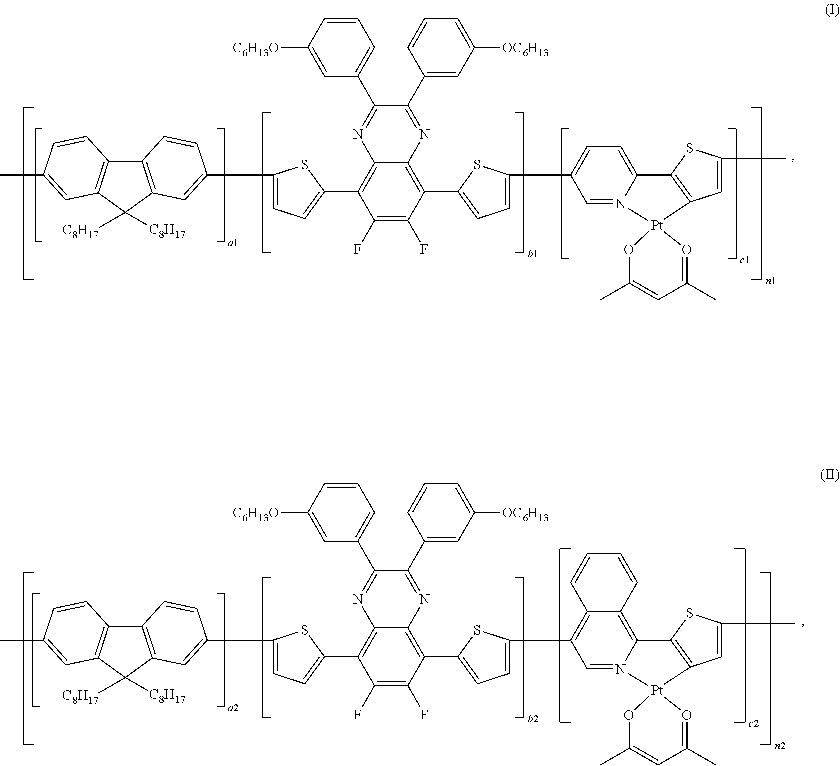
in the formula (I), a1≥0, b1≥0, a1+b1+c1=1, a1 and b1 are not 0 at the same time, and n1 is an integer of 1 to 100; and
in the formula (II), a2≥0, b2≥0, a2+b2+c2=1, a2 and b2 are not 0 at the same time, and n2 is an integer of 1 to 100.

13. The semiconductor compound of claim 12, wherein in the formula (I), a1=0.5, c1=0.05, 0.15 or 0.25, and b1=1-a1-c1, in the formula (II), a2=0.5, c2=0.05, 0.15 or 0.25, and b2=1-a2-c2.

14. The semiconductor compound of claim 1, wherein a particle diameter of the semiconductor compound is larger than 0 nm and less than or equal to 1000 μm.

15. A use of the semiconductor compound of claim 1 is used as a photocatalyst.

16. A hydrogen production system, comprising:
the semiconductor compound of claim 1.

17. The hydrogen production system of claim 16, wherein the hydrogen production system comprises a solution system, and the solution system comprises the semiconductor compound.

18. The hydrogen production system of claim 16, wherein the hydrogen production system comprises an electrode, and the electrode comprises the semiconductor compound.
